(19) United States
(12) Patent Application Publication
(10) Pub. No.: US 2026/0112832 A1
(43) Pub. Date: Apr. 23, 2026

(54) INFORMATION PROCESSING DEVICE HAVING A SOCKET CONNECTOR

(71) Applicant: HEWLETT PACKARD ENTERPRISE DEVELOPMENT LP, Spring, TX (US)

(72) Inventors: Chih-Wei Chiang, Taipei (TW); Chui Ching Chiu, Taipei (TW); Hsueh Yu Chao, Taipei (TW)

(21) Appl. No.: 18/919,727

(22) Filed: Oct. 18, 2024

(51) Int. Cl. H01R 13/05; H01R 12/71; H01R 13/631

(52) U.S. Cl. CPC H01R 13/055; H01R 12/716; H01R 13/631

(57) ABSTRACT

A socket connector for an information processing device includes a housing, first and second connectors, first and second communication connectors, and anti-skew flange container. The housing includes slots separated by dividers and formed between its first and second ends. The first connector includes first pins and a first housing portion having the first end and a first slot. The first communication connector includes second and third pins and a second housing portion positioned adjacent the first housing portion and having second and third slots. The anti-skew flange container includes a third housing portion adjacent the second housing portion. The second communication connector includes fourth and fifth pins and a fourth housing portion positioned adjacent the third housing portion and having fourth and fifth slots. The second connector includes sixth pins, and a fifth housing portion positioned adjacent the fourth housing portion and having the second end and a sixth slot.

### BACKGROUND

An information processing device such as a computer, a networking device, or the like may include a primary system board (e.g., a motherboard or a host platform module) having electronic components such as central processor units, resistors, capacitors, or the like to provide some basic function. To expand the functionality of the information processing device, additional electronic modules such as a riser card, an enterprise and datacenter standard form factor (EDSFF) backplane circuit board, or the like may have to be removably coupled to the primary system board. Therefore, the primary system board may include connectors that can detachably mate with complementary connectors of the electronic modules, thereby establishing an electrical connection between the electronic modules and the primary system board and expanding the functionality of the information processing device.

### BRIEF DESCRIPTION OF THE DRAWINGS

Various examples will be described below with reference to the following figures.

FIG. 1 includes a schematic top view of a socket connector according to an example of the present disclosure.

FIG. 2 includes a schematic top view of an information processing device including socket connectors of FIG. 1 according to an example of the present disclosure.

FIG. 3A includes a schematic side view of a portion of an electronic module according to an example of the present disclosure.

FIG. 3B includes a schematic side view of another portion of an electronic module according to an example of the present disclosure.

FIG. 4 includes a schematic side view of an electronic module such as a first riser card according to an example of the present disclosure.

FIG. 5 includes a schematic side view of an electronic module such as a second riser card or an enterprise and datacenter standard form factor (EDSFF) backplane circuit board according to an example of the present disclosure.

FIG. 6 includes a schematic top view of the information processing device of FIG. 2 having the socket connector removably coupled to the portion of the cable assembly of FIG. 3A according to an example of the present disclosure.

FIG. 7 includes a perspective view of a socket connector according to an example of the present disclosure.

FIG. 8 includes a perspective view of a portion of the information processing device having the socket connector of FIG. 7 according to an example of the present disclosure.

FIG. 9A includes a perspective view of an electronic module including a cable assembly according to an example of the present disclosure.

FIG. 9B includes a perspective view of a portion of the information processing device having the socket connector of FIG. 7 removable coupled to the cable assembly of FIG. 9A according to an example of the present disclosure.

FIG. 10A includes a perspective view of an electronic module including a first riser card according to an example of the present disclosure.

FIG. 10B includes a perspective view of a portion of the information processing device having the socket connector of FIG. 7 removable coupled to the first riser card of FIG. 10A according to an example of the present disclosure.

FIG. 11A includes a perspective view of an electronic module including a second riser card according to an example of the present disclosure.

FIG. 11B includes a perspective view of a portion of the information processing device having the socket connector of FIG. 7 removable coupled to the second riser card of FIG. 11A according to an example of the present disclosure.

FIG. 12 includes a perspective view of a portion of a second information processing device having a socket connector of FIG. 7 according to an example of the present disclosure.

FIG. 13A includes a perspective view of an electronic module including an enterprise and datacenter standard form factor (EDSFF) backplane circuit board according to an example of the present disclosure.

FIG. 13B includes a perspective view of a portion of the information processing device of FIG. 12 removable coupled to the EDSFF backplane circuit board of FIG. 13A according to an example of the present disclosure.

FIG. 14 is a flowchart depicting a method of installing a socket connector to a primary system board of an information processing device and removably coupling an electronic module to the socket connector according to one example of the present disclosure.

### DETAILED DESCRIPTION

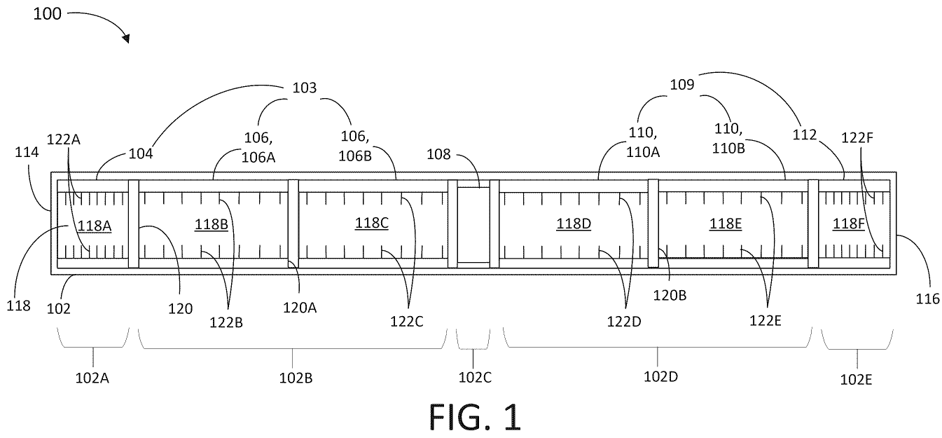

The following detailed description refers to the accompanying drawings. For purposes of explanation, certain examples are described with reference to the components illustrated in FIGS. 1-14. The functionality of the illustrated components may overlap, however, and may be present in a fewer or greater number of elements and components. Moreover, the disclosed examples may be implemented in various environments and are not limited to the illustrated examples. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the examples disclosed may be defined by the appended claims.

A primary system board of an information processing device such as a server includes connectors to facilitate inclusion of peripheral electronic modules such as a riser card, an enterprise and datacenter standard form factor (EDSFF) backplane circuit board, or the like in the information processing device to expand the functionality of the information processing device. The connectors are fixedly attached to the primary system board and are also electrically connected to internal circuitry of the primary system board. In such cases, when the electronic module is removably coupled to the information processing device, a complementary connector of the electronic module is detachably mated with the connector of the primary system board, thereby electrically connecting the electronic module to the information processing device via the connector and the complementary connector and expanding the functionality of the information processing device.

One type of connector arrangement is an edge connector and socket arrangement. In this arrangement, one connector of a pair is a PCB edge connector, which is formed in the edge of PCB, such as a PCB of a riser card, a PCB of a cable connector, or a PCB of another module, and another connector of the pair is a socket connector, which is configured to receive the PCB edge connector. In order to ensure compatibility between the edge connector and the socket connector, various form factors have been defined which specify the physical dimensions of the connectors, including specifying things such as the locations and shapes of keying features and the number and locations of electrical pins. A connector will be configured to support a certain number of communication channels, such as PCIe lanes, depending on the number and arrangement of electrical pins in the connector. For example, the modular extensible input output (M-XIO) family of connectors includes different varieties such as x4, x8, and x16 form factors, wherein x4 supports four PCIe lanes, x8 supports eight PCIe lanes, and x16 supports sixteen PCIe lanes.

However, in some circumstances, existing connector form factors may be insufficient to support a desired application e.g., they may have an insufficient number of communication channels (e.g., PCIe lanes). For example, in some instances, it may be desired to provide an electronic module such as a riser card with thirty-two PCIe lanes so that it can provide each of two expansion cards coupled thereto with sixteen PCIe lanes (or each of four expansion cards with eight PCIe lanes). But this is generally not feasible with existing connectors. For example, existing M-XIO connectors as specified in the relevant M-XIO standards have a maximum of sixteen PCIe lanes, which limits a riser card connected thereto to sixteen PCIe lanes.

To address these issues, examples disclosed herein include connectors which have form factors based on an existing family of form factors (such as M-XIO, for example), but which extend that family to allow for more communication channels than were previously possible. In particular, in some examples, connectors based on the M-XIO form factor are disclosed herein which have thirty-two PCIe lanes, which is double the previous sixteen PCIe lanes maximum for M-XIO connectors. This can allow for electronic modules such as the riser cards, EDFSS backplane circuit boards, cable connector modules, or other electronic modules to have more communication lanes, providing stronger performance for systems.

In some cases, example connectors disclosed herein may include two halves joined together end-to-end to share a same housing as one another, with each half having a form factor similar to that of a given connector form factor. For example, in an example 32-lane socket connector, each half may have a form factor similar to that of an x16 M-XIO socket connector. This arrangement may allow for the example connectors disclosed herein to be used in a variety of configurations. For example, assuming a 32-lane socket connector as an example, in a first configuration an edge connector supporting 32 lanes may mate with both halves of an example socket connector; in a second configuration, an edge connector having 16 lanes may mate with one half of the example socket connector, leaving the other half unused; and in a third configuration, two edge connectors each supporting 16 lanes may be mated with separate halves of the socket connector. Accordingly, the example connector can accept a variety of connection arrangements from a variety of differently sized connectors. This beneficially allows the same socket connector to be usable in multiple different systems with different configurations, rather than producing different types of connectors for different systems.

In some examples disclosed herein, the socket connector includes a housing, and first and second socket connector portions that are integrally formed within the housing. The housing includes a first end, a second end opposite to the first end, and a plurality of slots formed between the first and second ends and separated from one another by dividers. The first socket connector portion includes a first power and sideband receptacle connector and a first communication receptacle connector. The second socket connector portion includes a second power and sideband receptacle connector and a second communication receptacle connector. The socket connector further includes an anti-skew container positioned between the first and second socket connector portions.

The first power and sideband receptacle connector include a first portion of the housing and a first set of pins. The first portion includes the first end of the housing and a first slot of the plurality of slots. The first communication receptacle connector includes a second portion of the housing and second and third sets of pins. The second portion is positioned adjacent to the first portion and includes a second slot and a third slot of the plurality of slots. The anti-skew container includes a third portion of the housing. The third portion is positioned adjacent to the second portion. The second communication receptacle connector includes a fourth portion of the housing and fourth and fifth sets of pins. The fourth portion is positioned adjacent to the third portion and includes a fourth slot and a fifth slot of the plurality of slots. The second power and sideband receptacle connector include a fifth portion of the housing and a sixth set of pins. The fifth portion is positioned adjacent to the fourth portion and includes the second end of the housing and a sixth slot of the plurality of slots. Each of the second, third, fourth, and fifth sets of pins includes 8 pairs of communication pins. In one or more examples, the socket connector is mounted to the primary system board such that the first, second, third, fourth, fifth, and sixth sets of pins of the first and second power and sideband receptacle connectors and the first and second communication receptacle connectors are electrically connected to the primary system board. In such examples, the socket connector may be configured to removably couple with the electronic module to electrically connect the electronic module to the primary system board via at least one of the first and second communication receptacle connectors.

In one or more examples, the electronic module may include a cable assembly including a first cable and a second cable, a riser card, an enterprise and datacenter standard form factor (EDSFF) backplane circuit board, or the like, without deviating from the scope of the present disclosure. Each of the first cable, the second cable, the riser card, and the EDSFF backplane circuit board may include a complementary connector formed in an edge of printed circuit board (PCB) of a corresponding electronic module. Such complementary connectors may be referred to as an edge connector or plug connector. For example, the edge connector may be formed in the edge of a PCB of the riser card, a PCB of the cable connector, or a PCB of the EDSFF backplane circuit board.

In some examples, the first cable includes a first compatible connector (plug connector) having a first communication plug connector configured to detachably couple with the first communication receptacle connector and a first power and sideband plug connector configured to detachably couple with the first power and sideband receptacle connector. The second cable includes a second compatible connector (plug connector) having a second communication plug connector configured to detachably couple with the second communication receptacle connector, and a second power and sideband plug connector configured to detachably couple with the second power and sideband receptacle connector. It may be noted herein that the first communication receptacle connector and the first power and sideband plug connector may be discrete connectors or may be a single connector which is connected to the first cable. Similarly, the second communication receptacle connector and the second power and sideband plug connector may be discrete connectors or may the single connector which is connected to the second cable. In some examples, the first cable alone or concurrently with the second cable are configured to couple with the first socket connector portion and the second socket connector portion, respectively, of the socket connector. In certain examples, the first communication plug connector may include a first anti-skew flange disposed on its first end portion. Similarly, the second communication plug connector may include a second anti-skew flange disposed on its second end portion. In such examples, the anti-skew flange container of the socket connector is configured to receive the first and second anti-skew flanges and engage therewith to prevent the first and second communication plug connectors from skewing while detachably coupling with the first and second communication receptacle connectors, respectively.

In some other examples, a first riser card includes a complementary connector (an edge connector) having a first power and sideband plug connector, a first communication plug connector, a second communication plug connector, and a second power and sideband connector, positioned sequentially at an edge of a circuit board of the first riser card. In such example, in an installed state of the first riser card in the socket connector, the first and second power and sideband plug connectors are detachably coupled with the first and second power and sideband receptacle connectors, respectively, and the first and second communication plug connectors are detachably coupled with the first and second communication receptacle connectors, respectively, to electrically connect the first riser card with the primary system board via the socket connector.

In some other examples, a second riser card includes a complementary connector (an edge connector) having a first power and sideband plug connector and a first communication plug connector, positioned sequentially at an edge of a circuit board of the second riser card. In such examples, in an installed state of the second riser card in the socket connector, the first power and sideband plug connector is detachably coupled with the first or second power and sideband receptacle connector, and the first communication plug connector is detachably coupled with the first or second communication receptacle connector to electrically connect the second riser card with the primary system board via the socket connector.

Further, in some other examples, the EDSFF backplane circuit board includes a complementary connector (an edge connector) having a first power and sideband plug connector, a first communication plug connector, a second communication plug connector, and a second power and sideband connector, positioned sequentially at an edge of a circuit board of the EDSFF backplane circuit board. In such examples, in an installed state of the EDSFF backplane circuit board in the socket connector, the first and second power and sideband plug connectors are detachably coupled with the first and second power and sideband receptacle connectors, respectively, and the first and second communication plug connectors are detachably coupled with the first and second communication receptacle connectors, respectively, to electrically connect the EDSFF backplane circuit board with the primary system board via the socket connector.

In some examples, the socket connector is a modular extensible input output (M-XIO) socket connector. In such examples, the M-XIO socket connector includes 32 pairs of communication pins. In other words, the first socket connector portion (or a combination of the first power and sideband receptacle connector and the first communication receptacle connector) may have the M-XIO form factor. Similarly, the second socket connector portion (or a combination of the second power and sideband receptacle connector and the second communication receptacle connector) may have the M-XIO form factor. In particular, each of the second and third sets of pins of the first communication receptacle connector has 8 pairs of communication pins, and each of the fourth and fifth sets of pins of the second communication receptacle connector includes 8 pairs of communication pins.

In one or more examples, the socket connector as discussed hereinabove may be deployed in an information processing device having a chassis and a primary system board mounted to the chassis. In particular, the socket connector may be mounted to the primary system board and configured to removably mate with an electronic module having different form factors, to electrically connect the electronic module to the primary system board via at least one of the first and second communication receptacle connectors and thereby expand the functionality of the information processing device.

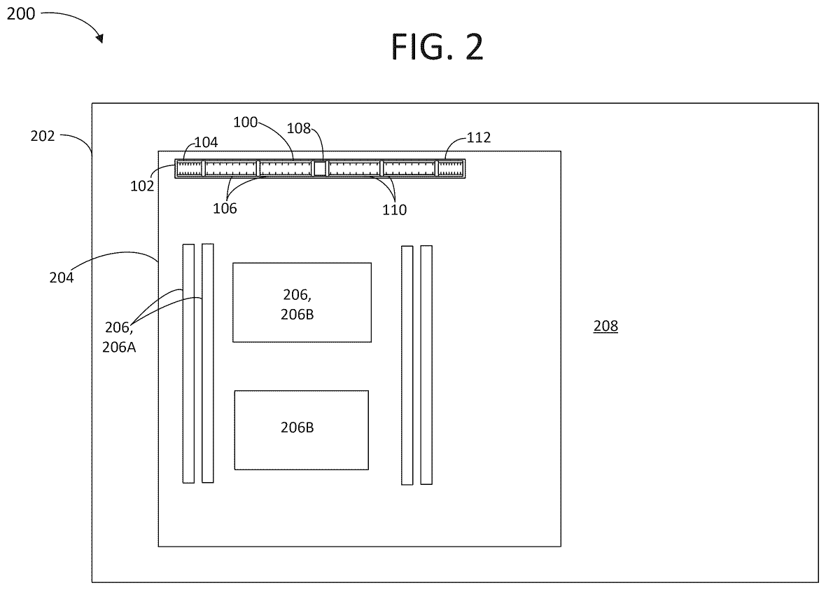

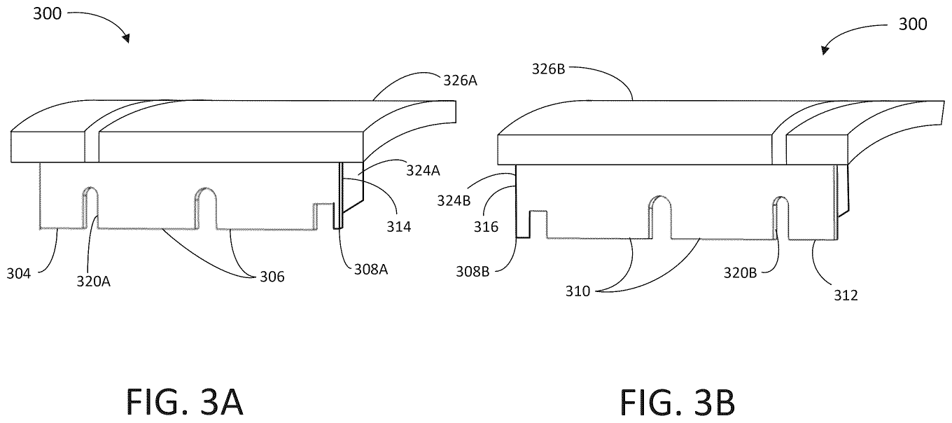

Referring to the Figures, FIG. 1 depicts a schematic top view of a socket connector 100 for mounting on a primary system board 204 of an information processing device 200 (as shown in FIG. 2). It should be understood that FIG. 1 is not intended to illustrate specific shapes, dimensions, or other structural details accurately or to scale, and that implementations of the socket connector 100 may have different numbers and arrangements of the illustrated components and may also include other parts that are not illustrated. The socket connector 100 may be a receptacle type connector which is configured to be fixedly attached to the primary system board 204 and electrically connected to an internal circuitry of the primary system board 204 to provide an interface for an electronic module such as a cable assembly 300 (as shown in FIG. 3) to be electrically connected to the primary system board 204.

In some examples, the socket connector 100 includes a housing 102, a first power and sideband receptacle connector 104, a first communication receptacle connector 106, an anti-skew flange container 108, a second communication receptacle connector 110, and a second power and sideband receptacle connector 112. It may be noted herein that the first power and sideband receptacle connector 104 and the first communication receptacle connector 106 together may be referred to as a first socket connector portion 103. Similarly, the second power and sideband receptacle connector 112 and the second communication receptacle connector 110 together may be referred to as a second socket connector portion 109.

The housing 102 may be a hollow receptacle element configured to house and provide support to power, sideband, and communication connector portions of the socket connector 100. In some examples, the housing 102 includes a first end 114, a second end 116 opposite to the first end 114, and a plurality of slots 118 formed between the first and second ends 114, 116 and separated from one another by dividers 120. In the example of FIG. 1, the housing 102 includes six slots 118, which are separated from each other by six dividers 120.

The first power and sideband receptacle connector 104 may be used to transfer power and sideband signals between the electronic module such as the cable assembly 300 and the primary system board 204. In some examples, the first power and sideband receptacle connector 104 includes a first portion 102A of the housing 102 and a first set of pins 122A. In some examples, the first portion 102A includes the first end 114 of the housing 102 and a first slot 118A. The first set of pins 122A is positioned in the first slot 118A and mounted to a sidewall and a mutually opposite sidewall (not labeled) of the first portion 102A. In some examples, when the socket connector 100 is mounted on the primary system board 204, the first set of pins 122A is configured to electrically connect with the internal circuitry of the primary system board 204. In such examples, when the electronic module such as the cable assembly 300 is removed coupled to the information processing device 200, the first slot 118A is configured to receive a first power and sideband plug connector (not shown) of the electronic module such as the cable assembly 300 such that the first set of pins 122A of the first power and sideband receptacle connector 104 is electrically connected to a first set of complementary pins of the first power and sideband plug connector.

The first communication receptacle connector 106 may be used to transfer data signals between the electronic module such as the cable assembly 300 and the primary system board 204. In some examples, the first communication receptacle connector 106 includes a first sub-communication receptacle connector 106A and a second sub-communication receptacle connector 106B disposed adjacent to one another and separated from each other by a first sub-divider wall 120A. In such examples, the first communication receptacle connector 106 includes a second portion 102B of the housing 102, a second set of pins 122B, and a third set of pins 122C. The second portion 102B is positioned adjacent to the first portion 102A and includes a second slot 118B and a third slot 118C which are separated from one another by the first sub-divider wall 120A. In such examples, the second set of pins 122B is positioned in the second slot 118B and mounted to a sidewall and a mutually opposite sidewall (not labeled) of the first sub-communication receptacle connector 106A. Similarly, the third set of pins 122C is positioned in the third slot 118C and mounted to a sidewall and a mutually opposite sidewall of the second sub-communication receptacle connector 106B. In some examples, each connector of the first sub-communication receptacle connector 106A and the second sub-communication receptacle connector 106B includes 8 pairs of pins. In other words, each of the second and third sets of pins 122B, 122C includes 8 pairs of communication pins. In some examples, when the socket connector 100 is mounted on the primary system board 204, the second and third set of pins 122B, 122C are configured to connect electrically with the internal circuitry of the primary system board 204. In such examples, when the electronic module such as the cable assembly 300 is removed coupled to the information processing device 200, the second and third slots 118B, 118C are configured to receive a first communication plug connector (not shown) of the electronic module such as the cable assembly 300 such that the second and third set of pins 122B, 122C of the first communication receptacle connector 106 are electrically connected to second and third set of complementary pins of the first communication plug connector.

The anti-skew flange container 108 is a component holder. In some examples, the anti-skew flange container 108 includes a third portion 102C of the housing 102. Further, the anti-skew flange container 108 is positioned adjacent to the second portion 102B of the housing 102. In one or more examples, the anti-skew flange container 108 is used to engage with a first anti-skew flange of the first communication plug connector and/or with a second anti-skew flange of a second communication plug connector of the electronic module such as the cable assembly 300, while detachably coupling with the first and/or second communication receptacle connectors, respectively.

The second communication receptacle connector 110 may also be used to transfer data signals between the electronic module such as the cable assembly 300 and the primary system board 204. In some examples, the second communication receptacle connector 110 includes a third sub-communication receptacle connector 110A and a fourth sub-communication receptacle connector 110B disposed adjacent to one another and separated from each other by a second sub-divider wall 120B. In such examples, the second communication receptacle connector 110 includes a fourth portion 102D of the housing 102, a fourth set of pins 122D, and a fifth set of pins 122E. The fourth portion 102D is positioned adjacent to the third portion 102C and includes a fourth slot 118D and a fifth slot 118E which are separated from one another by the second sub-divider wall 120B. In such examples, the fourth set of pins 122D is positioned in the fourth slot 118D and mounted to a sidewall and a mutually opposite sidewall of the third sub-communication receptacle connector 110A. Similarly, the fifth set of pins 122E is positioned in the fifth slot 118E such that the fifth set of pins 122E is mounted to a sidewall and a mutually opposite sidewall of the fourth sub-communication receptacle connector 110B. In some examples, each connector of the third sub-communication receptacle connector 110A and the fourth sub-communication receptacle connector 110B includes 8 pairs of pins. In other words, each of the fourth and fifth sets of pins 122D, 122E includes 8 pairs of communication pins. In some examples, when the socket connector 100 is mounted on the primary system board 204, the fourth and fifth set of pins 122D, 122E are configured to electrically connect with the internal circuitry of the primary system board 204. In such examples, when the electronic module such as the cable assembly 300 is removed coupled to the information processing device 200, the fourth and fifth slots 118D, 118E are configured to receive a second communication plug connector (not shown) of the electronic module such as the cable assembly 300 such that the fourth and fifth set of pins 122D, 122E of the second communication receptacle connector 110 are electrically connected to fourth and fifth set of complementary pins of the second communication plug connector.

The second power and sideband receptacle connector 112 may also be used to transfer power and sideband signals between the electronic module such as the cable assembly 300 and the primary system board 204. In some examples, the second power and sideband receptacle connector 112 includes a fifth portion 102E of the housing 102 and a sixth set of pins 122F. In some examples, the fifth portion 102E includes the second end 116 of the housing 102 and a sixth slot 118F. The sixth set of pins 122F is positioned in the sixth slot 118F and mounted to a sidewall and a mutually opposite sidewall of the fifth portion 102E. In some examples, when the socket connector 100 is mounted on the primary system board 204, the sixth set of pins 122F is configured to electrically connect with the internal circuitry of the primary system board 204. In such examples, when the electronic module such as the cable assembly 300 is removed coupled to the information processing device 200, the sixth slot 118F is configured to receive a second power and sideband plug connector (not shown) of the electronic module such as the cable assembly 300 such that the sixth set of pins 122F of the second power and sideband receptacle connector 112 is electrically connected to a sixth set of complementary pins of the second power and sideband plug connector.

In one or more examples, the first power and sideband receptacle connector 104, the first communication receptacle connector 106, the anti-skew flange container 108, the second communication receptacle connector 110, and the second power and sideband receptacle connector 112 are disposed sequentially from the first end 114 to the second end 116 of the housing 102 and are formed integrally in the housing 102. In some examples, each of the first socket connector portion 103 and the second socket connector portion 109 of the socket connector 100 has a first form factor, such as a modular extensible input output (M-XIO) form factor, without limiting the scope of the present disclosure. In other words, the first power and sideband receptacle connector 104 and the first communication receptacle connector 106 together have the M-XIO form factor. Similarly, the second power and sideband receptacle connector 112 and the second communication receptacle connector 110 together have an M-XIO form factor. However, the socket connector 100, as a whole, has a second form factor.

FIG. 2 depicts a schematic top view of an information processing device 200. It should be understood that FIG. 2 is not intended to illustrate specific shapes, dimensions, or other structural details accurately or to scale, and that implementations of the information processing device 200 may have different numbers and arrangements of the illustrated components and may also include other parts that are not illustrated. The information processing device 200 may be a computer (e.g., a server, a storage device), a networking device (e.g., a switch, an access point), or the like. In the example of FIG. 1, the information processing device 200 is a server. The information processing device 200 includes a chassis 202, a primary system board 204, a socket connector 100 of FIG. 1, and a plurality of electronic components, 206, e.g., DIMMS 206A, processors 206B, and the like.

The chassis 202 may be an enclosure formed by a pair of peripheral sidewalls (not shown), a base 208, a cover (not shown), a rear panel (not shown), and a front panel (not shown). In such examples, the pair of peripheral sidewalls may be connected to the base 208, the cover, the rear panel, and the front panel to define an internal volume (not labeled).

The primary system board 204 is positioned within the internal volume and mounted on the base 208 via a plurality of support members (not shown). In some examples, the primary system board 204 is a host processor module. In such examples, the host processor module may include the plurality of electronic components 206 as per the OCP guidelines. In the example of FIG. 2. The primary system board 204 includes DIMMS 206A and processors 206B such as central processing units and/or graphics processing units.

The socket connector 100 includes a housing 102, a first power and sideband receptacle connector 104, a first communication receptacle connector 106, an anti-skew flange container 108, a second communication receptacle connector 110, and a second power and sideband receptacle connector 112. In the example of FIG. 2, the socket connector 100 includes 32 pairs of communication pins. The socket connector 100 is mounted on a substrate (not labeled) of the primary system board 204 such that the socket connector 100 extends vertically from the substrate. In some examples, the socket connector 100 is fixedly attached to the primary system board 204 and is also electrically connected to internal circuitry (not shown) of the primary system board 204. In particular, each of the first, second, third, fourth, fifth, and sixth set of pins 122A, 122B, 122C, 122D, 122E, 122F of the socket connector 100 is electrically connected with the internal circuitry of the primary system board 204. In such examples, the socket connector 100 is configured to transfer power, sideband, and data signals between the electronic module and the primary system board. In certain examples, the socket connector 100 may be an M-XIO receptacle connector.

FIG. 3A depicts a schematic side view of a portion of an electronic module such as a portion of a cable assembly 300; and FIG. 3B depicts a schematic side view of another portion of the cable assembly 300. In some examples, the cable assembly 300 includes a first cable 326A and a second cable 326B. It should be understood that FIGS. 3A-3B are not intended to illustrate specific shapes, dimensions, or other structural details accurately or to scale, and that implementations of the cable assembly 300 may have different numbers and arrangements of the illustrated components and may also include other parts that are not illustrated.

The first cable 326A includes a first plug connector 324A including a first power and sideband plug connector 304, a first communication plug connector 306, and a first anti-skew flange 308A disposed at a first end portion 314 of the first communication plug connector 306. The first plug connector 324A further includes first recesses 320A. In some examples, one first recess 320A is formed between the first power and sideband plug connector 304 and the first communication plug connector 306, another first recess 320A is formed between the first communication plug connector 306, and yet another first recess 320A is formed at the first end portion 314. The first plug connector 324A may be compatible for detachably mating with the first socket connector portion 103. In other words, the first power and sideband plug connector 304 has a complementary profile to that of the first power and sideband receptacle connector 104 of the socket connector 100. Similarly, the first communication plug connector 306 has a complementary profile to that of the first communication receptacle connector 106 of the socket connector 100. Accordingly, in some examples, in an installed state of the first plug connector 324A of the first cable 326A in the socket connector 100, the power and sideband plug connector 304 is configured to detachably mate with the first power and sideband receptacle connector 104 and the first communication plug connector 306 is configured to detachably mate with the first communication receptacle connector 106. In such examples, the dividers 120 of the socket connector 100 may be positioned with the first recesses 320A, when the first plug connector 324A of the first cable 326A is detachably mated with the socket connector 100 so as to electrically connect the cable assembly 300 with the primary system board 204 via the socket connector 100. In some examples, the first plug connector 324A has an M-XIO form factor.

The second cable 326B includes a second plug connector 324B including a second power and sideband plug connector 312, a second communication plug connector 310, and a second anti-skew flange 308B disposed at a second end portion 316 of the second communication plug connector 310. The second plug connector 324B further includes second recesses 320B. In some examples, one second recess 320B is formed between the second power and sideband plug connector 312 and the second communication plug connector 310, another second recess 320B is formed between the second communication plug connector 310, and yet another second recess 320B is formed at the second end portion 316. The second plug connector 324B of the second cable 326B may be compatible for detachably mating with the second socket connector portion 109. In other words, the second power and sideband plug connector 312 has a complementary profile to that of the second power and sideband receptacle connector 112 of the socket connector 100. Similarly, the second communication plug connector 310 has a complementary profile to that of the second communication receptacle connector 110 of the socket connector 100. Accordingly, in some examples, in an installed state of the second plug connector 324B of the second cable 326B in the socket connector 100, the power and sideband plug connector 312 is configured to be detachably mated with the second power and sideband receptacle connector 112 and the second communication plug connector 310 is configured to be detachably mated with the second communication receptacle connector 110. In such examples, the dividers 120 of the socket connector 100 may be positioned with the second recesses 320B, while the second plug connector 324B of the second cable 326B is detachably mated with the socket connector 100 so as to electrically connect the cable assembly 300 with the primary system board 204 via the socket connector 100. In some examples, the second plug connector 324B has an M-XIO form factor.

In some examples, at least one of the first cable 326A or the second cable 326B may be used to removably couple with the socket connector 100. In some other examples, the first and second cables 326A, 326B may be used concurrently to removably couple with the socket connector 100. In all such examples, the first power and sideband receptacle connector 104 and the first communication socket receptacle connector 106 of the of the socket connector 100 is detachably mated with the first power and sideband plug connector 304 and the first communication plug connector 306 of the first plug connector 324A, respectively, and the second power and sideband receptacle connector 112 and the second communication receptacle connector 110 of the socket connector 100 is detachably mated with the second power and sideband plug connector 312 and the second communication plug connector 310 of the second plug connector 324B, respectively.

Further, the first anti-skew flange 308A and the second anti-skew flange 308B of the first plug connector 324A and the second plug connector 324B, respectively, are configured to engage with the anti-skew flange container 108 of the socket connector 100. In other words, the anti-skew flange container 108 is configured to receive the first and second anti-skew flanges 308A, 308B and engage therewith to prevent the first communication plug connector 306 and the second communication plug connector 310 of the cable assembly 300 from skewing while detachably coupling with the first and second communication receptacle connectors 106, 110, respectively, of the socket connector 100.

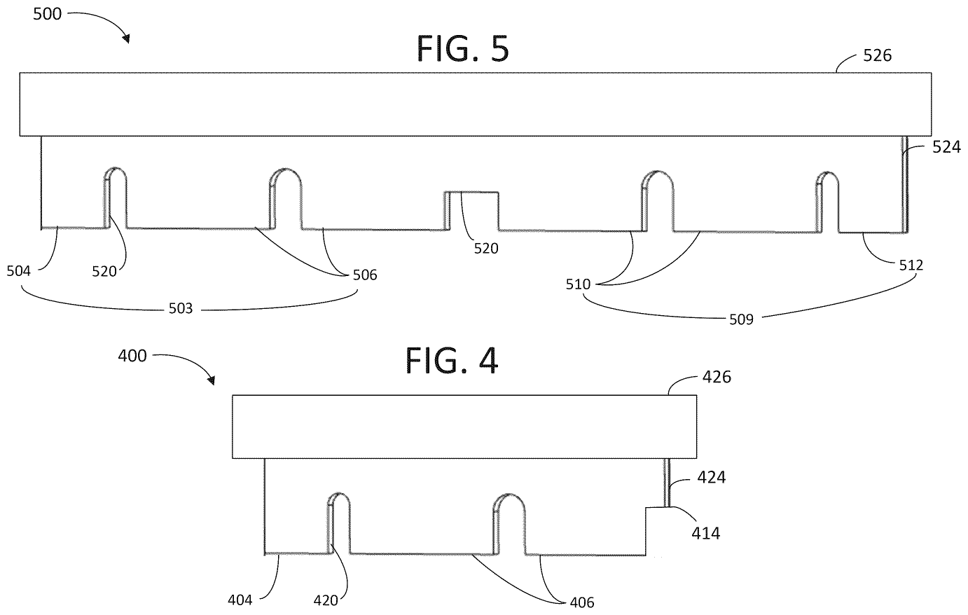

FIG. 4 depicts a schematic side view of a first riser card 400 such as a first riser card 400. It should be understood that FIG. 4 is not intended to illustrate specific shapes, dimensions, or other structural details accurately or to scale, and that implementations of the first riser card 400 may have different numbers and arrangements of the illustrated components and may also include other parts that are not illustrated.

The first riser card 400 includes an edge connector 424 extending vertically from a circuit board 426 of the first riser card 400. The edge connector 424 includes a first power and sideband plug connector 404 and a first communication plug connector 406 positioned sequentially at an edge of the first riser card 400. In some examples, the edge connector 424 further includes recesses 420. In particular, one recess 420 is formed between the first power and sideband plug connector 404 and the first communication plug connector 406, another recess 420 is formed between the first communication plug connector 406, and yet another recess 420 is formed at a first end 414 of the first communication plug connector 406. The edge connector 424 may be compatible for detachably mating with one of the first socket connector portion 103 or the second socket connector portion 109 of the socket connector 100. In other words, the first power and sideband plug connector 404 has a complementary profile to that of one of the first or second power and sideband receptacle connectors 104, 112. Similarly, the first communication plug connector 406 has a complementary profile to that of one of the first or second communication receptacle connectors 106, 110. Accordingly, in some examples, in an installed state of the edge connector 424 in the first socket connector portion 103, the first power and sideband plug connector 404 is configured to be detachably mated with the first power and sideband receptacle connector 104 and the first communication plug connector 406 is configured to be detachably mated with the first communication receptacle connector 106 so as to electrically connect the first riser card 400 with the primary system board 204 via the first socket connector portion 103. In some other examples, in the installed state of the edge connector 424 in the second socket connector portion 109, the first power and sideband plug connector 404 is configured to be detachably mated with the second power and sideband receptacle connector 112 and the first communication plug connector 406 is configured to be detachably mated with the second communication receptacle connector 110 so as to electrically connect the first riser card 400 with the primary system board 204 via the second socket connector portion 109. In such examples, the dividers 120 of the socket connector 100 may be positioned within a corresponding recess 420. In some examples, the edge connector 424 has an M-XIO form factor.

FIG. 5 depicts a schematic side view of an electronic module such as a second riser card 500 (or an enterprise and datacenter standard form factor (EDSFF) backplane circuit board). It should be understood that FIG. 5 is not intended to illustrate specific shapes, dimensions, or other structural details accurately or to scale, and that implementations of the second riser card 500 may have different numbers and arrangements of the illustrated components and may also include other parts that are not illustrated.

The second riser card 500 includes an edge connector 524 extending vertically from a circuit board 526 of the second riser card 500. The edge connector 524 includes a first power and sideband plug connector 504, a first communication plug connector 506, a second communication plug connector 510, and a second power and sideband plug connector 512 positioned sequentially at an edge of the second riser card 500. In some examples, the first power and sideband plug connector 504 and the first communication plug connector 506 may be referred to as a first edge connector portion 503. Similarly, the second power and sideband plug connector 512 and the second communication plug connector 510 may be referred to as a second edge connector portion 509. In some examples, the edge connector 524 further includes recesses 520. In particular, one recess 520 is formed between the first edge connector portion 503 and the second edge connector portion 509, another recess 520 is formed between the first power and sideband plug connector 504 and the first communication plug connector 506, yet another recess 520 is formed between the second power and sideband plug connector 512 and the second communication plug connector 510, yet another recess 520 is formed between the first communication plug connector 506, and yet another recess 520 is formed between the second communication plug connector 510. The edge connector 524 may be compatible for detachably mating with the socket connector 100. In other words, the first power and sideband plug connector 504 has a complementary profile to that of the first power and sideband receptacle connector 104 of the socket connector 100. Similarly, the first communication plug connector 506 has a complementary profile to that of the first communication receptacle connector 106 of the socket connector 100. Further, the second power and sideband plug connector 512 has a complementary profile to that of the second power and sideband receptacle connector 112 of the socket connector 100. Similarly, the second communication plug connector 510 has a complementary profile to that of the second communication receptacle connector 110 of the socket connector 100. Accordingly, in some examples, in an installed state of the edge connector 524 in the socket connector 100, the first power and sideband plug connector 504 is configured to be detachably mated with the first power and sideband receptacle connector 104, the first communication plug connector 506 is configured to be detachably mated with the first communication receptacle connector 106, the second communication plug connector 510 is configured to be detachably mated with the second communication receptacle connector 110, and the second power and sideband plug connector 512 is configured to be detachably mated with the second power and sideband receptacle connector 112 so as to electrically connect the second riser card 500 with the primary system board 204 via the socket connector 100. In such examples, the dividers 120 of the socket connector 100 may be positioned within a corresponding recess 520. In some examples, the edge connector 524 has an M-XIO form factor.

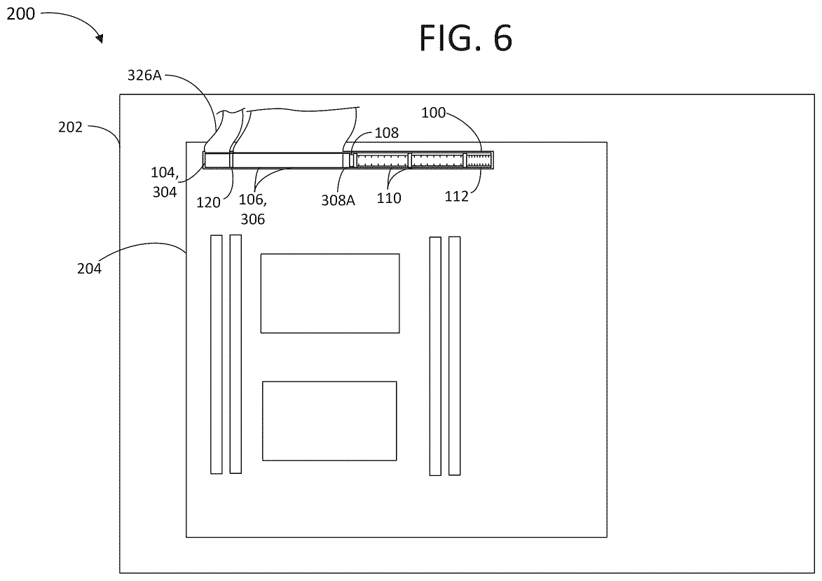

FIG. 6 depicts a schematic top view of the information processing device 200 of FIG. 2 having a chassis 202, a primary system board 204, and a socket connector 100. In some examples, the primary system board 204 is mounted on the chassis 202. The socket connector 100 is mounted on the primary system board 204. As discussed herein, the socket connector 100 includes a housing 102, a first power and sideband receptacle connector 104, a first communication receptacle connector 106, an anti-skew flange container 108, a second communication receptacle connector 110, and a second power and sideband receptacle connector 112. An electronic module may be removably coupled to the primary system board 204 via the socket connector 100 to expand the functionality of the information processing device 200. In some examples, the electronic module may be one of a cable assembly 300, a first riser card 1000, a second riser card 1100, or an EDSFF backplane circuit board 1300.

In the example of FIG. 6, a first cable 326A of the cable assembly 300 is detachably mated with the socket connector 100. In particular, a first power and sideband plug connector 304 of the first cable 326A is detachably mated with a first power and sideband receptacle connector 104 of the socket connector 100. Further, a first communication plug connector 306 of the first cable 326A is detachably mated with a first communication receptacle connector 106 of the socket connector 100. A first anti-skew flange 308A of the first cable 326A is engaged with an anti-skew flange container 108 of the socket connector 100. In other words, the anti-skew flange container 108 is configured to receive the first anti-skew flange 308A and engage therewith to prevent the first communication plug connector 306 from skewing while detachably coupling with the first communication receptacle connector 106. Even though not illustrated, the second cable 326B may be detachably mated with a second socket connector portion 109 of the socket connector 100, as discussed hereinabove.

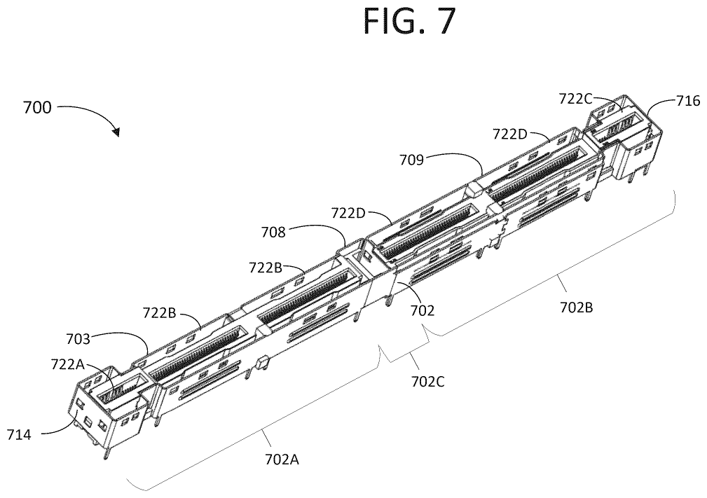

FIG. 7 depicts a perspective view of a socket connector e.g., a modular extensible input output (M-XIO) socket connector 700. In some examples, the M-XIO socket connector 700 includes a housing 702, a first M-XIO receptacle connector portion 703, a second M-XIO receptacle connector portion 709, and an anti-skew flange container 708. In some examples, the M-XIO socket connector 700 may also be referred to as an X32 M-XIO socket connector. The housing 702 includes a first end 714 and a second end 716 opposite to the first end 714. The first M-XIO receptacle connector portion 703 includes a first portion 702A of the housing 702, first power and sideband pins 722A, and 16 pairs of first communication pins 722B. The first portion further includes the first end 714. The second M-XIO receptacle connector portion 709 includes a second portion 702B of the housing 702, second power and sideband pins 722C, and 16 pairs of second communication pins 722D. The second portion 702B further includes the second end 716. The anti-skew flange container 708 including a third portion 702C of the housing 702 positioned between the first and second M-XIO receptacle connector portions 703, 709. In some examples, the first and second power and sideband pins 722A, 722C are positioned adjacent the first and second ends 714, 716 of the housing 702, respectively. Further, each of the first and second M-XIO receptacle connector portions 703, 709 has an M-XIO form factor. In some examples, the M-XIO socket connector 700 includes 32 pairs of communication pins (i.e., 16 pairs of first communication pins 722B and 16 pairs of second communication pins 722D).

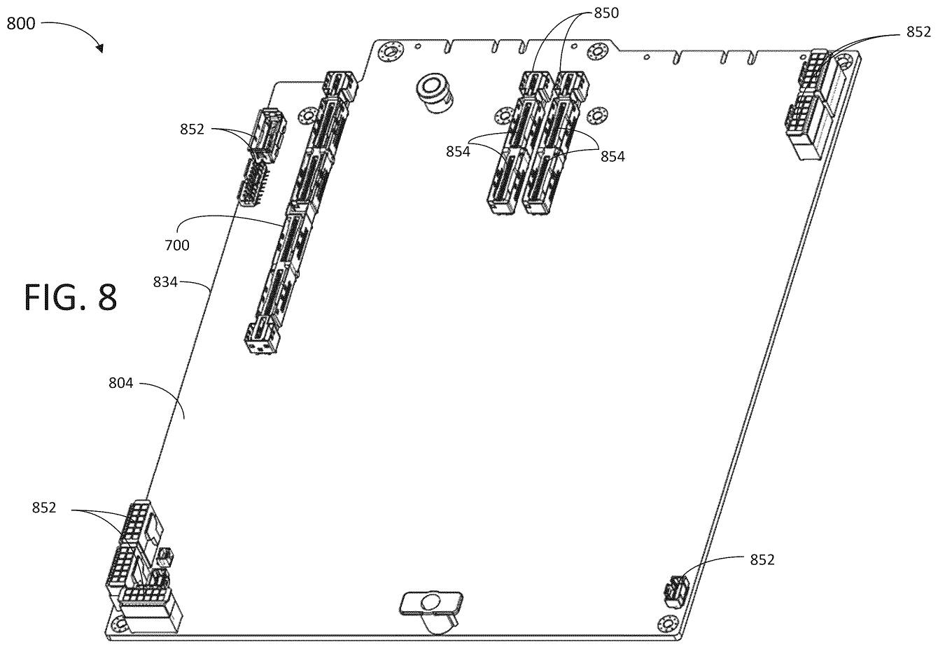

In some examples, each of the first and second M-XIO receptacle connector portions 703, 709 is configured to electrically connect with a primary system board 804 (as shown in FIG. 8) of an information processing device 800. Further, the M-XIO socket connector 700 is configured to removably mate with one of the electronic modules such as the cable assembly 900, a first riser card 1000, or a second riser card 1100 so as to electrically connect the one of the cable assembly 900, the first riser card 1000, or the second riser card 1100 to the primary system board 804 via at least one of the first and second M-XIO receptacle connector portions 703, 709.

FIG. 8 depicts a perspective view of an information processing device 800 including a chassis (not shown), a primary system board 804, an M-XIO socket connector 700 of FIG. 7, a plurality of auxiliary M-XIO socket connectors 850, and a plurality of electronic components 852. The primary system board 804 may be mounted to a base of the chassis. In some examples, the M-XIO socket connector 700 is positioned adjacent to a first peripheral side 834 of the primary system board 804 and mounted on the primary system board 804 such that the M-XIO socket connector 700 extends vertically upwards from the primary system board 804. Further, the M-XIO socket connector 700 is fixedly attached to the primary system board 804 and electrically connected to internal circuitry (not shown) of the primary system board 804. Further, each of the plurality of auxiliary M-XIO socket connectors 850 is disposed adjacent to the M-XIO socket connector 700 and extends parallel to the M-XIO socket connector 700. In the example of FIG. 8, each of the plurality of auxiliary M-XIO socket connectors 850 includes 16 pairs of communication pins 854 and has an M-XIO form factor. In some examples, the M-XIO socket connector 700 may be referred to as an X32 M-XIO socket connector and each of the plurality of auxiliary M-XIO socket connectors 850 may also be referred to as an X16 M-XIO socket connector.

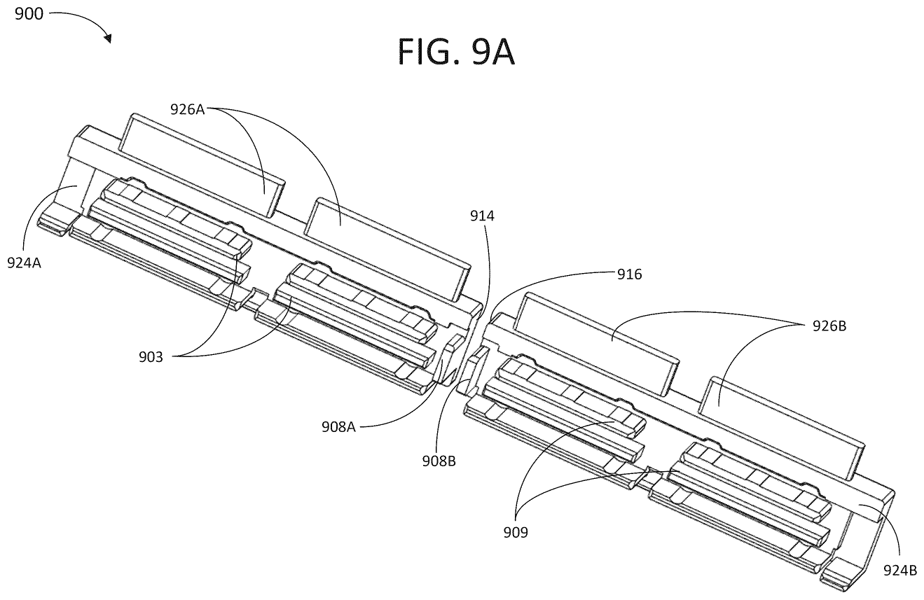

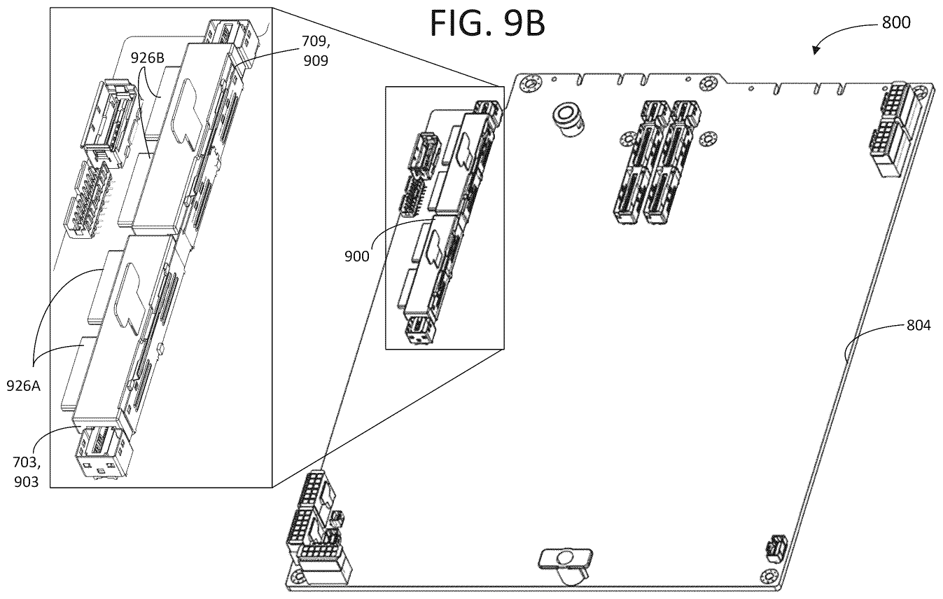

FIG. 9A depicts a perspective-bottom view of an electronic module, for example, a cable assembly 900. In some examples, the cable assembly 900 includes a first cable 926A and a second cable 926B.

The first cable 926A has a first plug connector 924A including a first M-XIO plug connector portion 903. The first M-XIO plug connector portion 903 includes first power and sideband plug pins (not shown), and 16 pairs of first communication plug pins 922B. It may be noted herein that the first power and sideband plug pins are not shown for ease of illustration and such non-illustration of the first power and sideband plug pins should not be construed as a limitation of the present disclosure. The first M-XIO plug connector portion 903 has a first form factor e.g., an M-XIO form factor. Thus, the first M-XIO plug connector portion 903 may be compatible with the first M-XIO receptacle connector portion 703 (as shown in FIGS. 7 and 8) so as to allow the first M-XIO plug connector portion 903 to detachably mate with the first M-XIO receptacle connector portion 703. The first M-XIO plug connector portion 903 further includes a first anti-skew flange 908A disposed on a first end portion 914 of the first M-XIO plug connector portion 903.

The second cable 926B has a second plug connector 924B, including a second M-XIO plug connector portion 909. The second M-XIO plug connector portion 909 includes second power and sideband plug pins (not shown), and 16 pairs of second communication plug pins 922D. It may be noted herein that the second power and sideband plug pins are not shown for ease of illustration and such non-illustration of the second power and sideband plug pins should not be construed as a limitation of the present disclosure. The second M-XIO plug connector portion 909 has the first form factor, e.g., the M-XIO form factor. Thus, the second M-XIO plug connector portion 909 may be compatible with the second M-XIO receptacle connector portion 709 (as shown in FIGS. 7 and 8) so as to allow the second M-XIO plug connector portion 909 to detachably mate with the second M-XIO receptacle connector portion 709. The second M-XIO plug connector portion 909 further includes a second anti-skew flange 908B disposed on a second end portion 916 of the second M-XIO plug connector portion 909.

In some examples, the first end portion 914 of the first M-XIO plug connector portion 903 and the second end portion 916 of the second M-XIO plug connector portion 909 may be coupled to each other to form the cable assembly 900. In such examples, the cable assembly 900 may have a second form factor. In one or more examples, the cable assembly 900 may be compatible with the M-XIO socket connector 700, as a whole, so as to allow the first and second M-XIO plug connector portions 903, 909 to detachably mate with the first and second M-XIO receptacle connector portions 703, 709, respectively.

FIG. 9B depicts a perspective view of the information processing device 800 of FIG. 8 having the cable assembly 900. In some examples, each of the first M-XIO plug connector portion 903 of the first cable 926A and the second M-XIO plug connector portion 909 of the second cable 926B may independently detachably mate with the first M-XIO receptacle connector portion 703 and the second M-XIO receptacle connector portion 709, respectively. In some other examples, the first M-XIO plug connector portion 903 and the second M-XIO plug connector portion 909 of the first and second cables 926A, 926B may concurrently detachably mate with the first M-XIO receptacle connector portion 703 and the second M-XIO receptacle connector portion 709, respectively. In all such examples, in an installed state of the first cable 926A in the M-XIO receptacle connector portion 703, the first M-XIO plug connector portion 903 is detachably coupled with the first M-XIO receptacle connector portion 703. Similarly, in the installed state of the second cable 726B in the M-XIO socket connector 700, the second M-XIO plug connector portion 909 is detachably coupled with the second M-XIO receptacle connector portion 703. Furthermore, the anti-skew flange container 708 receives the first and second anti-skew flanges 908A, 908B and engages therewith to prevent the first and second M-XIO plug connector portions 903, 909 from skewing while detachably coupling with the first and second M-XIO receptacle connector portions 703, 709, respectively. Thus, the anti-skew flange container 708 and the first and second anti-skew flanges 908A, 908B prevents any damage to the first and second M-XIO receptacle connector portions 703, 709.

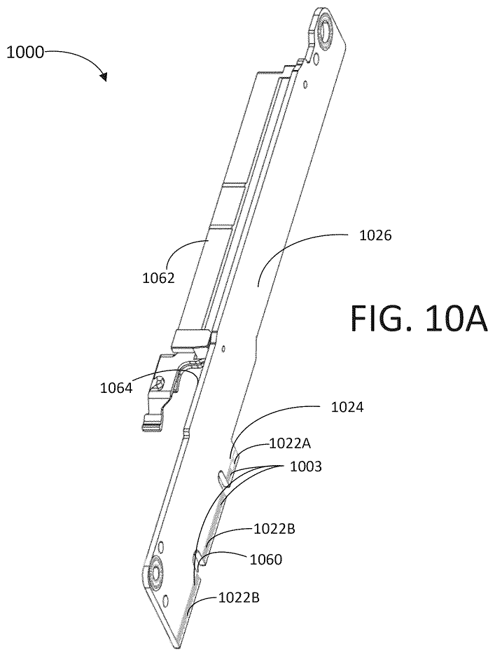

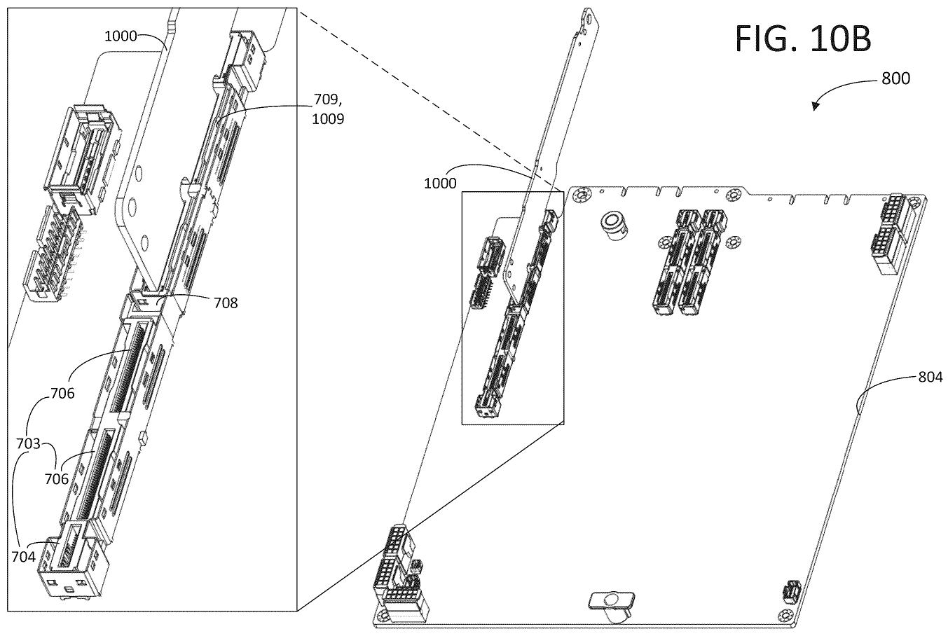

FIG. 10A depicts a perspective view of an electronic module, such as a first riser card 1000. In some examples, the first riser card 1000 includes a circuit board 1024, an edge connector 1026 extending vertically from the circuit board 1024, and an electrical connector 1062 extending from a face 1064 of the circuit board 1024. In such examples, the edge connector 1026 is electrically connected to the electrical connector 1062 via internal circuitry (not shown) in the circuit board 1024. Furthermore, the edge connector 1026 includes an M-XIO plug connector portion 1003 positioned at an edge 1060 of the circuit board 1024. In some examples, the M-XIO plug connector portion 1003 includes first power and sideband plug pins 1022A, and 16 pairs of second communication plug pins 1022B. The M-XIO plug connector portion 1003 has a first form factor e.g., an M-XIO form factor. Thus, the M-XIO plug connector portion 1003 may be compatible with the first M-XIO receptacle connector portion 703 (as shown in FIGS. 7 and 8) or the second M-XIO receptacle connector portion 709 so as to allow the M-XIO plug connector portion 1003 to detachably mate with one of the first or second M-XIO receptacle connector portions 703, 709.

FIG. 10B depicts a perspective view of the information processing device 800 of FIG. 8 having the first riser card 1000. The first riser card 1000 may be mounted on the first or second M-XIO receptacle connector portions 703, 709 and installed in the primary system board 804. In some examples, in an installed state of the first riser card 1000 in the M-XIO socket connector 700, the M-XIO plug connector portion 1003 is detachably mated with the first or second M-XIO receptacle connector portion 703, 709 to electrically connect the first riser card 1000 with the primary system board 804 via the M-XIO socket connector 700.

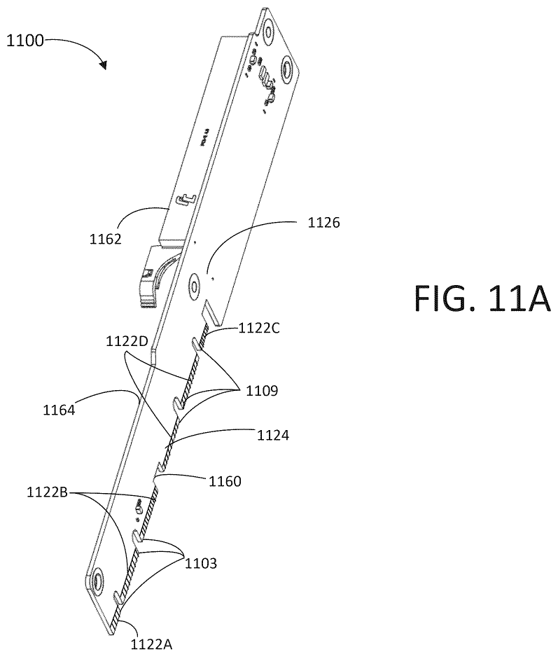

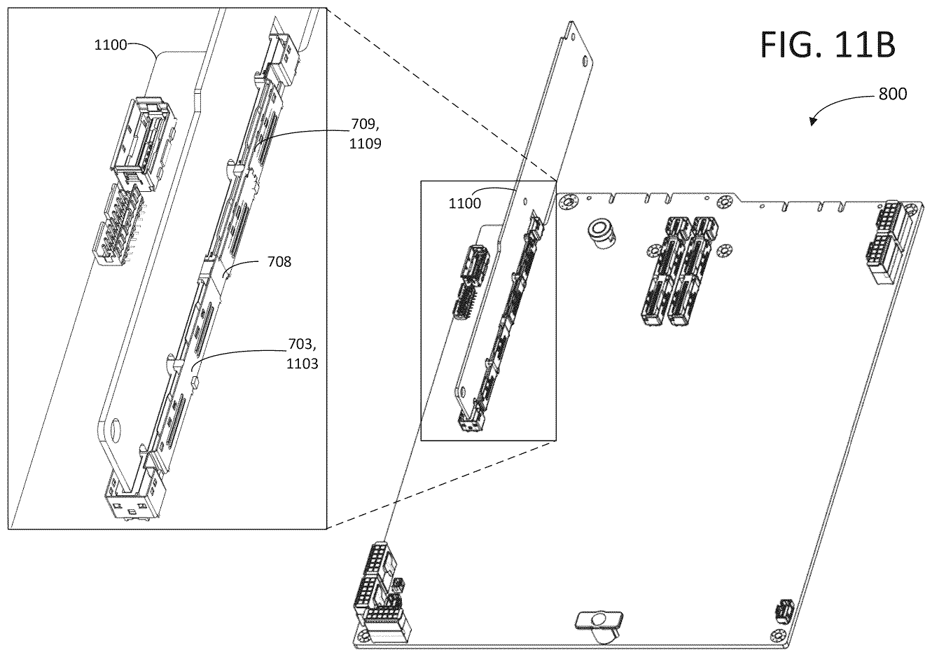

FIG. 11A depicts a perspective view of an electronic module, such as a second riser card 1100. In some examples, the second riser card 1100 includes a circuit board 1124, an edge connector 1126 extending vertically from the circuit board 1124, and an electrical connector 1162 extending from a face 1164 of the circuit board 1124. In such examples, the edge connector 1126 is electrically connected to the electrical connector 1162 via internal circuitry (not shown) in the circuit board 1124. Furthermore, the edge connector 1126 includes a first M-XIO plug connector portion 1103 and a second M-XIO plug connector portion 1109 positioned at an edge 1160 of the circuit board 1124. In some examples, the first M-XIO plug connector portion 1103 includes first power and sideband plug pins 1122A, and 16 pairs of second communication plug pins 1122B and the second M-XIO plug connector portion 1109 includes second power and sideband plug pins 1122C, and 16 pairs of second communication plug pins 1122D. Each of the first and second M-XIO plug connector portions 1103, 1109 has a first form factor e.g., an M-XIO form factor. However, the combination of the first and second M-XIO plug connector portions 1103, 1109 or the second riser card 1100 has a second form factor. Thus, first and second M-XIO plug connector portions 1103, 1109 of the second riser card 1100 may be compatible with the first and second M-XIO receptacle connector portions 703, 709 (as shown in FIGS. 7 and 8) so as to allow the first and second M-XIO plug connector portions 1103, 1109 to detachably mate with the first and second M-XIO receptacle connector portions 703, 709.

FIG. 11B depicts a perspective view of the information processing device 800 of FIG. 8 having the second riser card 1100. The second riser card 1100 may be mounted on the first and second M-XIO receptacle connector portions 703, 709 and installed in the primary system board 804. In some examples, in an installed state of the second riser card 1100 in the M-XIO socket connector 700, the first M-XIO plug connector portion 1103 is detachably mated with the first M-XIO receptacle connector portion 703 and the second M-XIO plug connector portion 1109 is detachably mated with the second M-XIO receptacle connector portion 709 to electrically connect the second riser card 1100 with the primary system board 804 via the M-XIO socket connector 700.

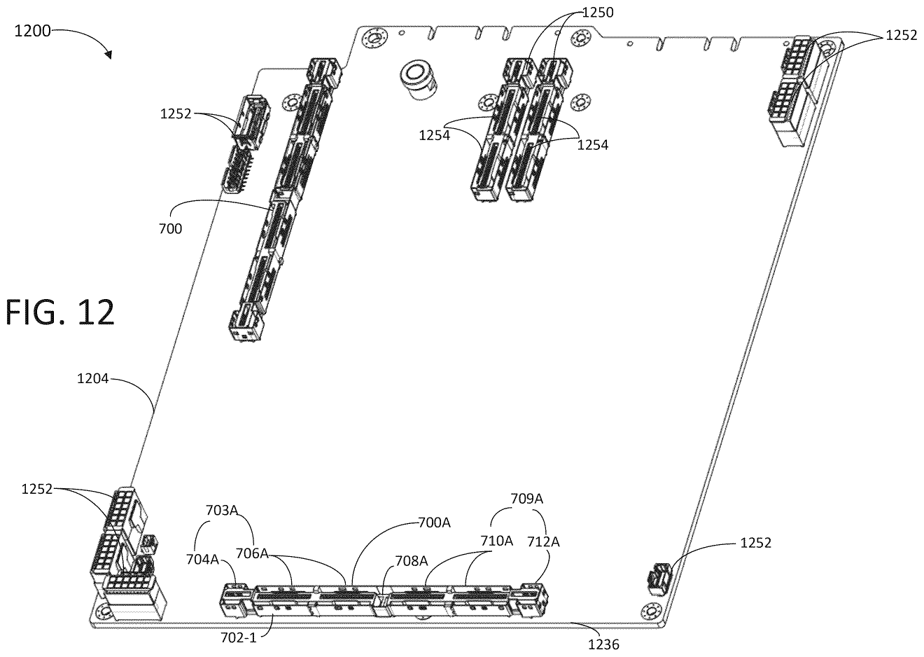

FIG. 12 depicts a perspective view of an information processing device 1200 including a chassis (not shown), a primary system board 1204, an M-XIO socket connector 700, a second M-XIO socket connector 700A, a plurality of auxiliary M-XIO socket connectors 1250, and a plurality of electronic components 1252. It may be noted that the M-XIO socket connector 700 is discussed in the example of FIG. 7 and the second M-XIO socket connector 700A is substantially similar to the M-XIO socket connector 700. Therefore, the second M-XIO socket connector 700A is not discussed in detail. The primary system board 1204 may be mounted to a base of the chassis. In some examples, the second M-XIO socket connector 700A is positioned adjacent to a rear side 1236 of the primary system board 1204 and mounted on the primary system board 1204 such that the second M-XIO socket connector 700A extends vertically upwards from the primary system board 1204. Further, the second M-XIO socket connector 700A is fixedly attached to the primary system board 1204 and electrically connected to internal circuitry (not shown) of the primary system board 1204. Additionally, each of the plurality of auxiliary M-XIO socket connectors 1250 is disposed adjacent to the M-XIO socket connector 700 and extends perpendicular to the second M-XIO socket connector 700A. In the example of FIG. 12, each of the plurality of auxiliary M-XIO socket connectors 1250 includes 16 pairs of communication pins 1254 and has an M-XIO form factor. In some examples, each of the M-XIO socket connector 700 and the second M-XIO socket connector 700A may be referred to as an X32 M-XIO socket connector, and each of the plurality of auxiliary M-XIO socket connectors 1250 may also be referred to as an X16 M-XIO socket connector.

In some examples, the second M-XIO socket connector 700A includes a housing 702-1, a first M-XIO receptacle connector portion 703A, a second M-XIO receptacle connector portion 709A, and an anti-skew flange container 708A. In some examples, the first M-XIO receptacle connector portion 703A includes a first power and sideband receptacle connector 704A and a first communication receptacle connector 706A. The second M-XIO receptacle connector portion 709A includes a second power and sideband receptacle connector 704B and a second communication receptacle connector 706B.

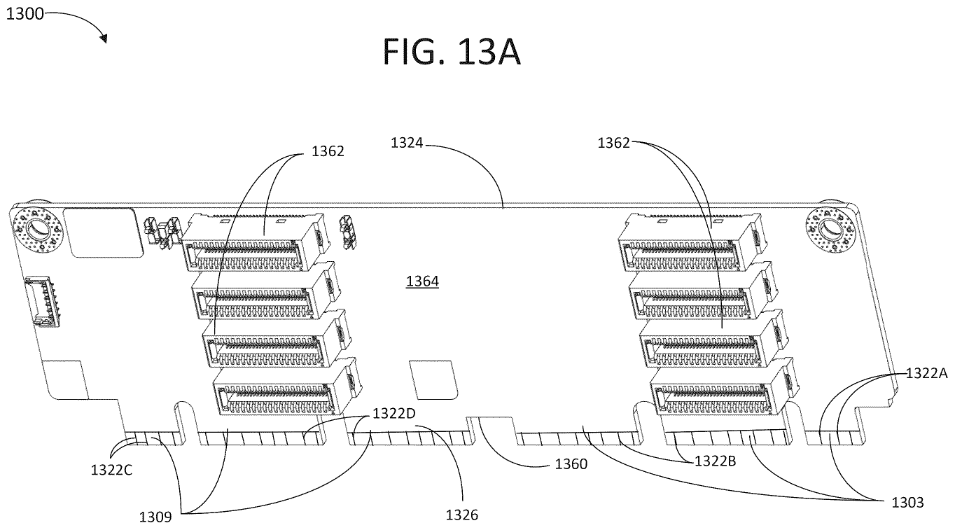

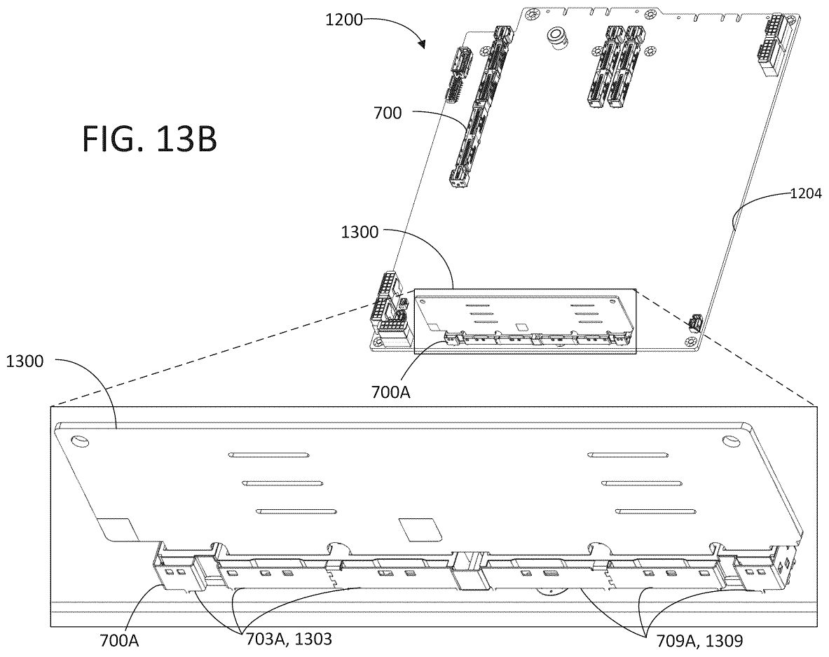

FIG. 13A depicts a perspective view of an electronic module, such as an enterprises and datacenter standard form factor (EDSFF) backplane circuit board 1300. In some examples, the EDSFF backplane circuit board 1300 includes a circuit board 1324, an edge connector 1326 extending vertically from the circuit board 1324, and a plurality of electrical connectors 1362 extending from a face 1364 of the circuit board 1324. In such examples, the edge connector 1326 is electrically connected to the plurality of electrical connectors 1362 via internal circuitry (not shown) in the circuit board 1324. Furthermore, the edge connector 1326 includes a first M-XIO plug connector portion 1303 and a second M-XIO plug connector portion 1309 positioned at an edge 1360 of the circuit board 1324. In some examples, the first M-XIO plug connector portion 1303 includes first power and sideband plug pins 1322A and 16 pairs of second communication plug pins 1322B, and the second M-XIO plug connector portion 1309 includes second power and sideband plug pins 1322C and 16 pairs of second communication plug pins 1322D. Each of the first and second M-XIO plug connector portions 1303, 1309 has a first form factor e.g., an M-XIO form factor. However, the combination of the first and second M-XIO plug connector portions 1303, 1309 or the EDSFF backplane circuit board 1300, as a whole, has a second form factor. Thus, first and second M-XIO plug connector portions 1303, 1309 of the EDSFF backplane circuit board 1300 may be compatible with the first and second M-XIO receptacle connector portions 703A, 709A (as shown in FIG. 12) so as to allow the first and second M-XIO plug connector portions 1303, 1309 to detachably mate with the first and second M-XIO receptacle connector portions 703A, 709A.

FIG. 13B depicts a perspective view of the information processing device 1200 of FIG. 12 having the EDSFF backplane circuit board 1300. The EDSFF backplane circuit board 1300 may be mounted on the first and second M-XIO receptacle connector portions 703A, 709A and installed in the primary system board 1204. In some examples, in an installed state of the EDSFF backplane circuit board 1300 in the second M-XIO socket connector 700A, the first M-XIO plug connector portion 1303 is detachably mated with the first M-XIO receptacle connector portion 703A and the second M-XIO plug connector portion 1309 is detachably mated with the second M-XIO receptacle connector portion 709A to electrically connect the EDSFF backplane circuit board 1300 with the primary system board 1204 via the second M-XIO socket connector 700A.

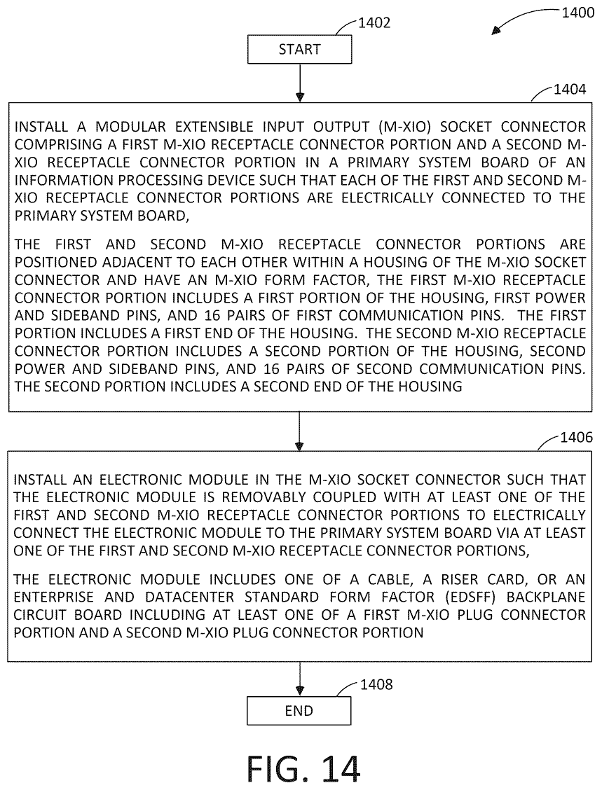

FIG. 14 depicts a flowchart showing a method 1400 of installing a socket connector to a primary system board of an information processing device and removably coupling an electronic module to the socket connector. It may be noted herein that the method 1400 is described in conjunction with FIGS. 7-8, 9A-9B, 10A-10B, 11A-11B, 12, and 13A-13B, for example. The method 1400 starts at block 1402 and continues to block 1404.

At block 1404, the method 1400 includes installing a modular extensible input output (M-XIO) socket connector including a first M-XIO receptacle connector portion and a second M-XIO receptacle connector portion in a primary system board of an information processing device such that each of the first and second M-XIO receptacle connector portions are electrically connected to the primary system board, as discussed herein the example of FIGS. 8 and 12. In some examples, the first and second M-XIO receptacle connector portions are positioned adjacent to each other within a housing of the M-XIO socket connector and have an M-XIO form factor. The first M-XIO receptacle connector portion includes a first portion of the housing, first power and sideband pins, and 16 pairs of first communication pins. The first portion includes a first end of the housing. The second M-XIO receptacle connector portion includes a second portion of the housing, second power and sideband pins, and 16 pairs of second communication pins. The second portion includes a second end of the housing. The method 1400 continues to block 1406.

At block 1406, the method 1400 includes installing an electronic module in the M-XIO socket connector such that the electronic module is removably coupled with at least one of the first and second M-XIO receptacle connector portions to electrically connect the electronic module to the primary system board via at least one of the first and second M-XIO receptacle connector portions, as discussed in the examples of FIGS. 9A-9B, 10A-10B, 11A-11B, and 13A-13B. The electronic module includes one of a cable assembly as discussed in FIGS. 9A-9B, a first riser card as discussed in FIGS. 10A-10B, a second riser card, as discussed in FIGS. 11A-11B, or an enterprise and datacenter standard form factor (EDSFF) backplane circuit board, as discussed in FIGS. 13A-13B, including at least one of a first M-XIO plug connector portion and a second M-XIO plug connector portion.

In some examples, the M-XIO socket connector, such as the cable assembly, further includes an anti-skew flange container including a third portion of the housing positioned between the first and second M-XIO receptacle connector portions. The cable assembly includes a first cable having the first M-XIO plug connector portion and a second cable having the second M-XIO plug connector portion. The first M-XIO plug connector portion includes a first anti-skew flange disposed on a first end portion of the first M-XIO plug connector portion. The second M-XIO plug connector portion includes a second anti-skew flange disposed on a second end portion of the second M-XIO plug connector portion. The anti-skew flange container receives the first and second anti-skew flanges and engages therewith to prevent the first and second M-XIO plug connector portions from skewing while detachably coupling with the first and second M-XIO receptacle connector portions, respectively. The method 1400 ends at block 1408.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed is:

1. An information processing device comprising:
a chassis;
a primary system board mounted to the chassis; and
a socket connector mounted to the primary system board, comprising:
a housing comprising a first end, a second end opposite to the first end, and a plurality of slots formed between the first and second ends and separated from one another by dividers;
a first power and sideband receptacle connector comprising a first portion of the housing and a first set of pins, the first portion comprising the first end and a first slot of the plurality of slots;
a first communication receptacle connector comprising a second portion of the housing and second and third sets of pins, the second portion positioned adjacent the first portion and comprising a second slot and a third slot of the plurality of slots;
an anti-skew flange container comprising a third portion of the housing adjacent the second portion,
a second communication receptacle connector comprising a fourth portion of the housing and fourth and fifth sets of pins, the fourth portion positioned adjacent the third portion and comprising a fourth slot and a fifth slot of the plurality of slots; and
a second power and sideband receptacle connector comprising a fifth portion of the housing and a sixth set of pins, the fifth portion positioned adjacent the fourth portion and comprising the second end and a sixth slot of the plurality of slots,
wherein the first, second, third, fourth, fifth, and sixth sets of pins of the first and second power and sideband receptacle connectors and the first and second communication receptacle connectors are electrically connected to the primary system board, and
wherein the socket connector is configured to removably couple with an electronic module to electrically connect the electronic module to the primary system board via at least one of the first and second communication receptacle connectors.

2. The information processing device of claim 1, wherein each of the second, third, fourth, and fifth sets of pins comprises 8 pairs of communication pins.

3. The information processing device of claim 1,
wherein the electronic module comprises a first cable comprising a first communication plug connector configured to detachably mate with the first communication receptacle connector, and
wherein the socket connector is configured to removably couple with, concurrently with the first cable, a second cable comprising a second communication plug connector configured to detachably mate with the second communication receptacle connector.

4. The information processing device of claim 3, wherein the first cable further comprises a first power and sideband plug connector, wherein the second cable further comprises a second power and sideband plug connector,
wherein, in an installed state of the first cable in the socket connector, the first power and sideband plug connector is detachably mated with the first power and sideband receptacle connector and the first communication plug connector is detachably mated with the first communication receptacle connector; and
wherein, in the installed state of the second cable in the socket connector, the second power and sideband plug connector is detachably mated with the second power and sideband receptacle connector and the second communication plug connector is detachably mated with the second communication receptacle connector.

5. The information processing device of claim 4, wherein the first communication plug connector comprises a first anti-skew flange disposed on a first end portion of the first communication plug connector, wherein the second communication plug connector comprises a second anti-skew flange disposed on a second end portion of the second communication plug connector, and
wherein the anti-skew flange container is configured to receive the first and second anti-skew flanges and engage therewith to prevent the first and second communication plug connectors from skewing while detachably coupling with the first and second communication receptacle connectors, respectively.

6. The information processing device of claim 1, wherein the electronic module comprises a first riser card having an edge connector including a first power and sideband plug connector and a first communication plug connector, positioned sequentially at an edge of a circuit board of the first riser card; and
wherein, in an installed state of the first riser card in the socket connector, the first power and sideband plug connector is detachably mated with the first or second power and sideband receptacle connector, and the first communication plug connector is detachably mated with the first or second communication receptacle connector to electrically connect the first riser card with the primary system board via the socket connector.

7. The information processing device of claim 1, wherein the electronic module comprises a second riser card having an edge connector including a first power and sideband plug connector, a first communication plug connector, a second communication plug connector, and a second power and sideband connector, positioned sequentially at an edge of a circuit board of the second riser card; and
wherein, in an installed state of the second riser card in the socket connector, the first and second power and sideband plug connectors are detachably mated with the first and second power and sideband receptacle connectors, respectively, and the first and second communication plug connectors are detachably mated with the first and second communication receptacle connectors, respectively, to electrically connect the second riser card with the primary system board via the socket connector.

8. The information processing device of claim 1, wherein the electronic module comprises an enterprise and datacenter standard form factor (EDSFF) backplane circuit board having an edge connector including a first power and sideband plug connector, a first communication plug connector, a second communication plug connector, and a second power and sideband connector, positioned sequentially at an edge of a circuit board of the EDSFF backplane circuit board; and
wherein, in an installed state of the EDSFF backplane circuit board in the socket connector, the first and second power and sideband plug connectors are detachably mated with the first and second power and sideband receptacle connectors, respectively, and the first and second communication plug connectors are detachably mated with the first and second communication receptacle connectors, respectively, to electrically connect the EDSFF backplane circuit board with the primary system board via the socket connector.

9. The information processing device of claim 1,
wherein the first power and sideband receptacle connector and the first communication receptacle connector together have a modular extensible input output (M-XIO) form factor; and
wherein the second power and sideband receptacle connector and the second communication receptacle connector together have an M-XIO form factor.

10. An information processing device:
a chassis;
a primary system board mounted to the chassis; and
a modular extensible input output (M-XIO) socket connector mounted to the primary system board, comprising:
a housing comprising a first end and a second end opposite to the first end;
a first M-XIO receptacle connector portion comprising a first portion of the housing, first power and sideband pins, and 16 pairs of first communication pins, the first portion comprising the first end;
a second M-XIO receptacle connector portion comprising a second portion of the housing, second power and sideband pins, and 16 pairs of second communication pins, the second portion comprising the second end; and
an anti-skew flange container comprising a third portion of the housing positioned between the first and second M-XIO receptacle connector portions,
wherein each of the first and second M-XIO receptacle connector portions is electrically connected to the primary system board, and
wherein the M-XIO socket connector is configured to removably couple with an electronic module to electrically connect the electronic module to the primary system board via at least one of the first and second M-XIO receptacle connector portions.

11. The information processing device of claim 10, wherein the first and second power and sideband pins are positioned adjacent the first and second ends of the housing, respectively.

12. The information processing device of claim 10,
wherein the electronic module comprises a first cable comprising a first M-XIO plug connector portion,
wherein the M-XIO socket connector is configured to removably couple with, concurrently with the first cable, a second cable comprising a second M-XIO plug connector portion.
wherein, in an installed state of the first cable in the M-XIO socket connector, the first M-XIO plug connector portion is detachably mated with the first M-XIO receptacle connector portion; and
wherein, in the installed state of the second cable in the M-XIO socket connector, the second M-XIO plug connector portion is detachably mated with the second M-XIO receptacle connector portion.

13. The information processing device of claim 12, wherein the first M-XIO plug connector portion comprises a first anti-skew flange disposed on a first end portion of the first M-XIO plug connector portion, wherein the second M-XIO plug connector portion comprises a second anti-skew flange disposed on a second end portion of the second M-XIO plug connector portion, and
wherein the anti-skew flange container is configured to receive the first and second anti-skew flanges and engage therewith to prevent the first and second M-XIO plug connector portions from skewing while detachably coupling with the first and second M-XIO receptacle connector portions, respectively.

14. The information processing device of claim 10, wherein the electronic module comprises a first riser card having an edge connector including an M-XIO plug connector portion positioned at an edge of a circuit board of the first riser card; and
wherein, in an installed state of the first riser card in the M-XIO socket connector, the M-XIO plug connector portion is detachably mated with the first or second M-XIO receptacle connector portion to electrically connect the first riser card with the primary system board via the M-XIO socket connector.

15. The information processing device of claim 10, wherein the electronic module comprises a second riser card having an edge connector including a first M-XIO plug connector portion and a second M-XIO plug connector portion, positioned sequentially at an edge of a circuit board of the second riser card; and
wherein, in an installed state of the second riser card in the M-XIO socket connector, the first and second M-XIO plug connector portions are detachably mated with the first and second M-XIO receptacle connector portions, respectively, to electrically connect the second riser card with the primary system board via the M-XIO socket connector.

16. The information processing device of claim 10, wherein the electronic module comprises an enterprise and datacenter standard form factor (EDSFF) backplane circuit board having an edge connector including a first M-XIO plug connector portion and a second M-XIO plug connector portion, positioned sequentially at an edge of a circuit board of the EDSFF backplane circuit board; and
wherein, in an installed state of the EDSFF backplane circuit board in the M-XIO socket connector, the first and second M-XIO plug connector portions are detachably mated with the first and second M-XIO receptacle connector portions, respectively, to electrically connect the EDSFF backplane circuit board with the primary system board via the M-XIO socket connector.

17. The information processing device of claim 10, each of the first and second M-XIO receptacle connector portions have an M-XIO form factor.

18. The information processing device of claim 10, wherein the M-XIO socket connector comprises 32 pairs of communication pins.

19. A method comprising:
installing a modular extensible input output (M-XIO) socket connector comprising a first M-XIO receptacle connector portion and a second M-XIO receptacle connector portion in a primary system board of an information processing device such that each of the first and second M-XIO receptacle connector portions are electrically connected to the primary system board,
wherein the first and second M-XIO receptacle connector portions are positioned adjacent to each other within a housing of the M-XIO socket connector and have an M-XIO form factor, wherein the first M-XIO receptacle connector portion comprises a first portion of the housing, first power and sideband pins, and 16 pairs of first communication pins, the first portion comprising a first end of the housing, and wherein the second M-XIO receptacle connector portion comprises a second portion of the housing, second power and sideband pins, and 16 pairs of second communication pins, the second portion comprising a second end of the housing,
installing an electronic module in the M-XIO socket connector such that the electronic module is removably coupled with at least one of the first and second M-XIO receptacle connector portions to electrically connect the electronic module to the primary system board via at least one of the first and second M-XIO receptacle connector portions,
wherein the electronic module comprises one of a cable, a riser card, or an enterprise and datacenter standard form factor (EDSFF) backplane circuit board comprising at least one of a first M-XIO plug connector portion and a second M-XIO plug connector portion.

20. The method of claim 19, wherein the M-XIO socket connector further comprises an anti-skew flange container comprising a third portion of the housing positioned between the first and second M-XIO receptacle connector portions, wherein the cable comprises a first cable comprising the first M-XIO plug connector portion and a second cable comprising the second M-XIO plug connector portion, wherein the first M-XIO plug connector portion comprises a first anti-skew flange disposed on a first end portion of the first M-XIO plug connector portion, wherein the second M-XIO plug connector portion comprises a second anti-skew flange disposed on a second end portion of the second M-XIO plug connector portion, and wherein the anti-skew flange container receives the first and second anti-skew flanges and engages therewith to prevent the first and second M-XIO plug connector portions from skewing while detachably coupling with the first and second M-XIO receptacle connector portions, respectively.
